(19) United States
(12) Patent Application Publication
(10) Pub. No.: US 2025/0370967 A1
(43) Pub. Date: Dec. 4, 2025

(54) CALCULATED DICTIONARY COLUMN CREATION

(71) Applicant: SAP SE, Walldorf (DE)

(72) Inventors: Nico Bohnsack, Mauer (DE); Andreas Amler, Heidelberg (DE); Till Merker, Sandhausen (DE)

(21) Appl. No.: 18/677,549

(22) Filed: May 29, 2024

(51) Int. Cl. G06F 16/21; G06F 16/215; G06F 16/22

(52) U.S. Cl. CPC G06F 16/213; G06F 16/215; G06F 16/221

(57) ABSTRACT

In an example embodiment, rather than apply an operation to the values of an original data table, the operation is applied to the values in the dictionary table corresponding to the column of the original data table on which the operation is being performed. This produces what is termed a “dictionary column”, which is a column that contains cells having values indicating the results applying the operation to the rows of the corresponding dictionary table.

### BACKGROUND

A database may be configured to store a plurality of electronic data records. These data records may be organized, in accordance with a database schema, into various database objects including, for example, one or more database tables. The database is coupled with a database management system (DBMS), which may be configured to support a variety of database operations for accessing the data records stored in the database. These database operations may include, for example, structured query language (SQL) queries and/or the like.

### BRIEF DESCRIPTION OF DRAWINGS

The present disclosure is illustrated by way of example and not limitation in the figures of the accompanying drawings, in which like references indicate similar elements.

FIG. 1 is a diagram illustrating a data table in accordance with an example embodiment. Here, the data table includes four columns.

FIG. 2 is a diagram illustrating dictionary tables for several of the columns of the data table of FIG. 1.

FIG. 3 is a diagram illustrating a dictionary column, in accordance with an example embodiment.

FIG. 4 is a block diagram illustrating an example of a database management system, in accordance with some example implementations.

FIG. 5 is a flow diagram illustrating a method for forming a database command, in accordance with an example embodiment.

FIG. 6 is a block diagram illustrating a software architecture, in accordance with an example embodiment.

FIG. 7 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Various operations may be performed on data stored in databases. Specifically, it is common to perform operations on every piece of data in a column of a table stored in a database. Typically, the way these operations are executed at the database level is that the value of the cell of the column is read out and the operation performed on that value, with the process repeating row-by-row until all of the rows have been processed. While this works fine in many scenarios, with certain types of operations and certain types of values it can cause wasteful processing, which slows execution of the operation.

For example, the command “LEFT” has two parameters, one indicating the column that it should be applied on and the second indicating the number of characters that should be extracted from the values in the cells of the column, starting at the left-most position. For example, if a cell in column A is a string “BCDE” and a LEFT (A, 2) command is executed, then for that cell “BC” will be the output of the execution of the command. Executions of these types of commands can be computationally expensive.

When the data in the cells in a column has low cardinality (i.e. where there are a relatively low number of unique values), it may be possible to reduce the computational expense by utilizing a more efficient mechanism to process an operation performed row-by-row on cells in that column. As such, in an example embodiment, a more efficient mechanism is provided by creating a dictionary column from a dictionary table corresponding to values in the column. The dictionary table contains a different row for each unique value in a cell of the column, and a special dictionary column can be created for the operation by applying the operation to the values in the rows in the dictionary table instead of applying it to the values in the rows of the data table.

A dictionary table is an auxiliary data structure that maps value identifiers (“value IDs”) to distinct values within a column of a data table. The value IDs are usually integers. If the distinct values are strings, the dictionary is called a string dictionary.

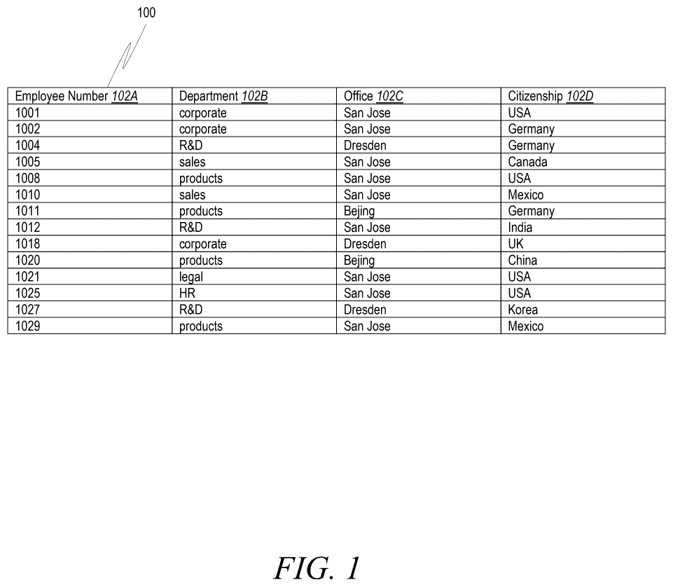

FIG. 1 is a diagram illustrating a data table 100 in accordance with an example embodiment. Here, the data table 100 includes four columns 102A-102D. Each row of the data table 100 contains a value for each of the four columns 102A-102D. Notably, some of these values repeat within the column. For example, in the department column 102B, the term “corporate” appears in several cells.

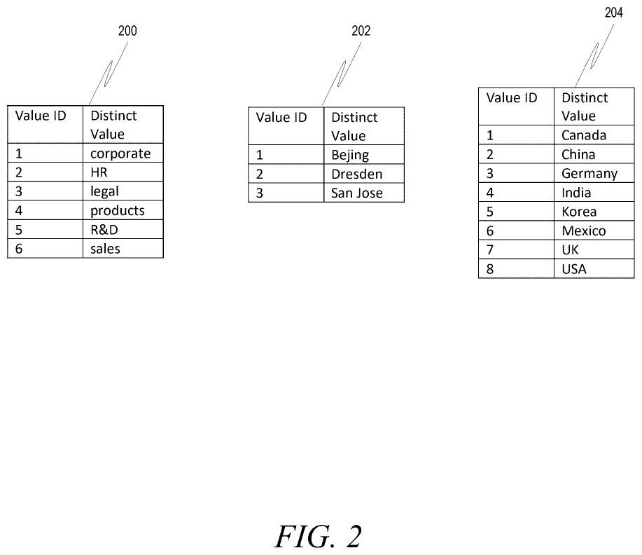

FIG. 2 is a diagram illustrating dictionary tables 200, 202, 204 for several of the columns of the data table 100 of FIG. 1. A dictionary table 200 corresponds to the department column 102B, a dictionary table 202 corresponds to the office column 102C, and a dictionary table 204 corresponds to the citizenship column 102D. Each of the dictionary tables 200, 202, 204 contain a value identification column and a distinct value column, and cells that map value identifications to the distinct values within each corresponding column of the data table 100. Thus, for example, the dictionary table 200 contains six value identifications, each corresponding to a different distinct value that appears in the cells of the department column 102B of the data table 100.

In an example embodiment, rather than apply an operation to the values of the original data table 100, the operation is applied to the values in the dictionary table 200, 202, 204 corresponding to the column of the original data table 100 on which the operation is being performed. Thus, if the operation is “LEFT (department, 2)”, which signifies that all data values in the department column 102B should have their left-most two characters extracted, then rather than apply this operation to the values in the department column 102B itself, this operation is applied to the dictionary table 200 corresponding to the department column 102B. This produces what is termed a “dictionary column”, which is a column that contains cells having values indicating the results of applying the operation to the rows of the corresponding dictionary table.

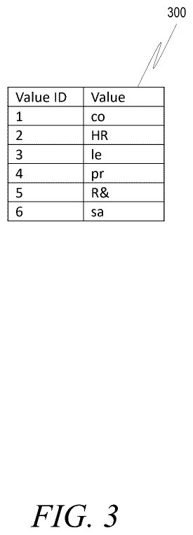

FIG. 3 is a diagram illustrating a dictionary column 300, in accordance with an example embodiment. Here, the dictionary column 300 corresponds to, as mentioned above, the results of a “LEFT (department, 2)” that is applied to the dictionary table 200 of FIG. 2.

A mapping is also created between the original value identification from the corresponding dictionary table (here the dictionary table 200) and the newly calculated value. In an example embodiment, this mapping is represented by storing the values in the dictionary column 300 in the same row as their corresponding value identification in the dictionary table 200. Thus, for example, the first row of the dictionary column 300 corresponds to the value identification of “1” since that is the value identification stored in the first row of the dictionary table 200. There may be other ways of storing a mapping between the original value identification from the corresponding dictionary table and the newly calculated value, however, so this technique of lining the rows of the dictionary column up with the rows of the dictionary table is not intended to be interpreted as the only implementation of such a mapping. Other mappings, such as pointers, keys, etc., could be used instead.

The result is that far fewer iterations of the operation need to be performed to obtain the same results as applying the operation to every row of the original data table 100. Thus, for example, if the original data table had one hundred rows in it, then previously an execution of the “LEFT (department, 2)” would need to result in one hundred different string operations, while using the presently described techniques reduces the number of different string operations to 6 (the cardinality of the department column 102B). This results in tremendous computational savings, especially in large database tables with relatively low cardinality.

In some example embodiments the dictionary column may be further condensed by removing duplicate rows, basically creating a dictionary column having only unique values in it. Of course, since this condensation results in the dictionary column no longer having its rows line up with the rows of the dictionary table, a separate mapping may be maintained between rows of the dictionary column and the identifications in the dictionary table.

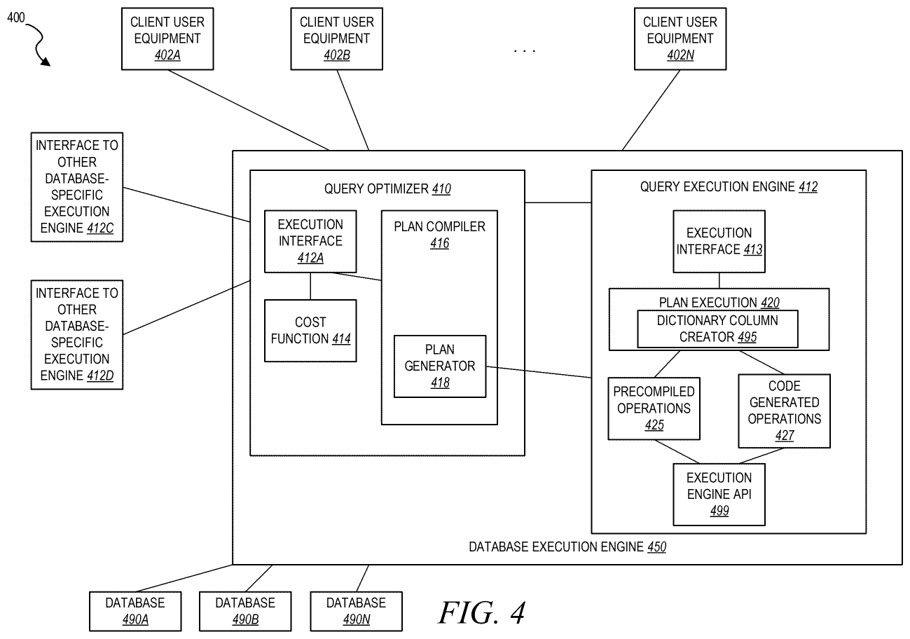

FIG. 4 is a block diagram illustrating an example of a database management system 400, in accordance with some example implementations.

The database management system 400 may include one or more user equipment 402A-N, such as a computer, a smartphone, a tablet, an Internet of Things (IoT) device, and/or other computer or processor-based devices. The user equipment may include a user interface, such as a browser or other application to enable access to one or more applications, database layer(s), and/or databases, to generate queries to one or more databases 490A-N, and/or to receive responses to those queries.

In the example of FIG. 4, the databases 490A-N represent the database layer of a database management system where data may be persisted and/or stored in a structured way, and where the data can be queried or operated on using operations including SQL commands or other types of commands/instructions to provide reads, writes, and/or perform other operations. To illustrate by way of an example, user equipment 402A-N may send a query via an execution engine 450 to the database layer 490A-N, which may represent a persistence and/or storage layer where database tables may be stored and/or queried. The query may be sent via a connection, such as a wired and/or wireless connection (e.g., the Internet, cellular links, WiFi links, and/or the like).

The database execution engine 450 may include a query optimizer 410, such as a SQL optimizer and/or another type of optimizer, to receive at least one query from a user equipment and generate a query plan (which may be optimized) for execution by the execution engine 412. The query optimizer 410 may receive a request, such as a query, and then form or propose an optimized query plan. The query plan (which may be optimized) may be represented as a so-called “query algebra” or “relational algebra.”

For example, “SELECT Columns from Table A and Table B, and perform an INNER JOIN on Tables A and B” may represent a query received by the database execution engine 450 including the query optimizer 410. There may be several ways of implementing execution of this query. As such, the query plan may offer hints or propose an optimum query plan with respect to the execution time of the overall query. To optimize a query, the query plan optimizer 410 may obtain one or more costs for the different ways the execution of the query plan can be performed. The costs may be obtained via the execution interface 412A from a cost function 414, which responds to the query optimizer 410 with the cost(s) for a given query plan (or portion thereof), and these costs may be in terms of execution time at the database layer 490A-N, for example.

The query optimizer 410 may form an optimum query plan, which may represent a query algebra, as noted above. To compile a query plan, the query optimizer 410 may provide the query plan to the query plan compiler 416 to enable compilation of some, if not all, of the query plan. The query plan compiler 416 may compile the optimized query algebra into operations, such as program code and/or any other type of command, operation, object, or instruction. This code may include pre-compiled code (which can be pre-compiled and stored, and then selected for certain operations in the query plan) and/or just-in-time code generated specifically for execution of the query plan. For example, the plan compiler may select pre-compiled code for a given operation as part of the optimization of the query plan, while for another operation in the query plan the plan compiler may allow a compiler to generate the code. The pre-compiled and generated code represents code for executing the query plan, and this code may be provided to the plan generator 418, which interfaces the query execution engine 412.

In some implementations, the query optimizer 410 may optimize the query plan by compiling and generating code. Moreover, the query optimizer 410 may optimize the query plan to enable pipelining during execution.

In some implementations, the query optimizer 410 may be configured to select other execution engines. For example, the query optimizer 410 may select via interface 412C an execution engine configured specifically to support a row-store database or an ABAP type database, or the query optimizer 410 may select via interface 412D an execution engine configured specifically to support a column-store type database. In this way, the query optimizer 410 may select whether to use the universal database execution engine 450 or legacy (e.g., database-specific) execution engines (available via interfaces 412C/D, for example).

The query execution engine 412 may receive, from the plan generator 418, compiled code to enable execution of the optimized query plan, although the query execution engine may also receive code or other commands directly from a higher-level application or other device, such as user equipment 402A-N.

The query execution engine 412 may then forward, via an execution interface 412B, the code to a plan execution engine 420. The plan execution engine 420 may then prepare the plan for execution, and this query plan may include pre-compiled code 425 and/or generated code 427. When the code for the query plan is ready for execution during runtime, the query execution engine 412 may step through the code performing some of the operations within the database execution engine 450 and sending some of the operations (or commands in support of an operation, such as a read, write, and/or the like) to the execution engine application programming interface (API) 499 for execution at one or more of databases layers 490A-N.

In an example embodiment, the plan execution engine 420 is modified to include a dictionary column creator 495. The dictionary column creator 495 identifies all columns of a data table in one of the databases 490A-190N on which an operation contained in the query plan is performed. The dictionary column creator 495 then identifies a dictionary table for each of these columns (which likely will be stored in their respective databases 490A-490N, although this is not mandatory).

The dictionary column creator 495 then generates a dictionary column for the operation by applying the operation to the corresponding dictionary tables for the involved one or more columns.

In some example embodiments, the dictionary column creator 495 is implemented as an operator that is only invoked if the optimization described by the present disclosure is performed. There may be a number of instances where it is not desirable to perform the optimization, including if a dictionary table for the column or columns involved does not exist, if the cardinality of the column or columns involved is not sufficiently low to see significant computational savings, if the cost function 414 indicates that the optimization is not worth the cost for the particular scenario, if the operation is not one that is likely to result in computational savings, etc. Examples of operations that are likely to result in computational savings include commands to extract portions of data, such as strings, from rows, commands to filter a column, and join operations performed on the column.

Generating the dictionary column itself may involve first reserving memory for the dictionary column(s) and then traversing the corresponding dictionary table(s) to perform the appropriate calculation(s) to obtain the output of the operation. This output is written into the earlier prepared memory and can be persisted in the database. Alternatively, the output could be written to a temporary data structure that exists only during the query execution.

In a further example embodiment and parallelization may be used to further reduce the computational complexity of evaluation of the operation. More specifically, the dictionary table(s) may be partitioned into blocks of predefined size. This allows a column with a large dictionary to be handled by multiple different workers. Along with the dictionary table(s) being partitioned, the dictionary column(s) may also be partitioned in a similar manner and parallelized.

As mentioned above, the presently-described solution may only provide optimization benefits for certain types of operations and in certain types of operations. As such, in an example embodiment, various techniques may be used to limit the application of the presently-described solution to those circumstances where it is warranted.

One such technique is to identify operations that would tend to benefit from such an optimization and limit application of the presently-described solution to just those identified operations. These operations could be individually identified, or identified on the basis of some common trait or group of traits. Thus, for example, it may be desirable to limit the potential operations on which this optimization will be performed to operations that involve some process be performed on each row of a column in a database. This would include, for example, operations that include a scalar operation.

Another technique is to use a heuristic to identify instances where the cardinality of the column(s) involved is/are sufficiently low. Specifically, a ratio of the cardinality of a column to the number of rows in the column may be computed and compared to a set threshold. For example, a threshold of 5% would cause the presently-described solution to be applied only to columns whose cardinality-to-total-row ratio is less than or equal to 0.05. Thus, if the column of the data table has 1000 rows and its cardinality is 60, then the presently-described solution is not applied, but if the cardinality is 40, then the presently-described solution is applied.

This threshold may be fixed in some example embodiments, but in other example embodiments it may be dynamically determined. For example, a machine learning model may be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbors, decision trees, and hidden Markov models.

In an example embodiment, a machine learning algorithm used to train such machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

Training data may include computer code that has been labeled as either being something along the lines of “cardinality is sufficiently low” or “cardinality is not sufficiently low”. From this training data, the machine learning algorithm trains the machine learning model to learn how to identify scenarios where the cardinality is sufficiently low to run the presently-described procedures involving a dictionary column.

In some example embodiments, the training of the machine learning model may take place as a dedicated training phase. In other example embodiments, the machine learning model may be retrained dynamically at runtime based on, for example, developer or user feedback.

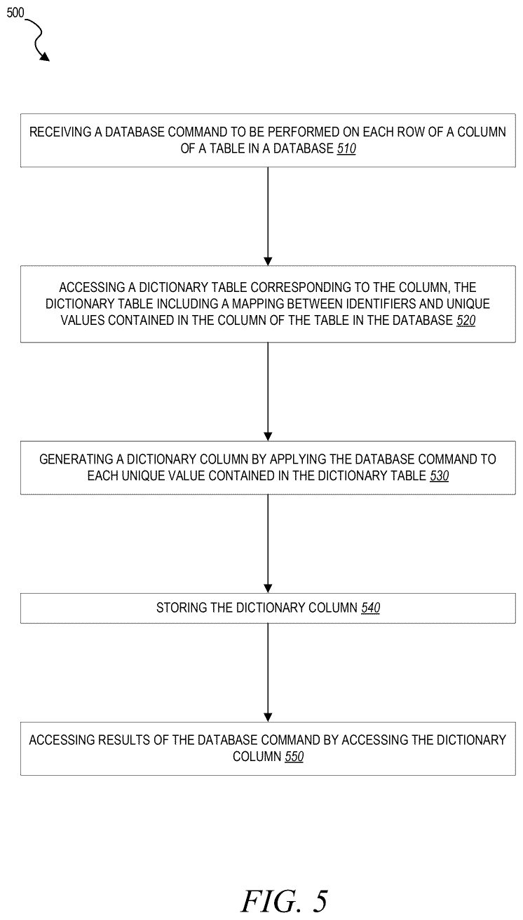

FIG. 5 is a flow diagram illustrating a method 500 for forming a database command, in accordance with an example embodiment.

At step 510, a database command to be performed on each row of a column of a table in a database is received. At step 520, a dictionary table corresponding to the column is accessed. The dictionary table includes a mapping between identifiers and unique values contained in the column of the table in the database.

At step 530, a dictionary column is generated by applying the database command to each unique value contained in the dictionary table. At step 540, the dictionary column is stored. At step 550, results of the database command are accessed by accessing the dictionary column.

In view of the above-described implementations of subject matter, this application discloses the following list of examples, wherein one feature of an example in isolation or more than one feature of said example taken in combination and, optionally, in combination with one or more features of one or more further examples are further examples also falling within the disclosure of this application:

Example 1 is a system comprising: at least one hardware processor; and a computer-readable medium storing instructions that, when executed by the at least one hardware processor, cause the at least one hardware processor to perform operations comprising: receiving a database command to be performed on each row of a column of a table in a database; accessing a dictionary table corresponding to the column, the dictionary table including a mapping between identifiers and unique values contained in the column of the table in the database; generating a dictionary column by applying the database command to each unique value contained in the dictionary table; storing the dictionary column; and accessing results of the database command by accessing the dictionary column.

In Example 2, the subject matter of Example 1 includes, wherein each row in the column of the table contains one of the identifiers in the mapping in the dictionary table, indicating that the corresponding unique value in the mapping corresponds to a value for the corresponding row.

In Example 3, the subject matter of Example 2 includes, wherein the accessing results includes using the dictionary column along with the dictionary table to identify values in the dictionary column that correspond to each row of the column of the table in the database.

In Example 4, the subject matter of Example 3 includes, wherein the dictionary column is organized so that each row of the dictionary column lined up with a corresponding row of the dictionary table so that each row of the dictionary column contains a result of applying the database command to a unique value in the corresponding row in the dictionary table.

In Example 5, the subject matter of Examples 1-4 includes, wherein the operations further comprise: determining whether a ratio of cardinality of the column to number of rows in the column is less than a threshold; and wherein the receiving, accessing, generating, and storing are performed in response to a determination that the ratio of cardinality of the column to number of rows in the column is less than the threshold ratio.

In Example 6, the subject matter of Example 5 includes, wherein the threshold ratio is determined by a machine learning model trained to output an optimal threshold ratio for a particular scenario in which the database command is being executed.

In Example 7, the subject matter of Examples 1-6 includes, wherein the operations further comprise: breaking the dictionary table into multiple dictionary tables; and generating separate dictionary columns for each of the multiple dictionary tables using parallel computing.

In Example 8, the subject matter of Examples 1-7 includes, wherein the operations further comprise: generating a condensed version of the dictionary column by eliminating duplicate instances of an identical value in rows of the dictionary column and maintaining a mapping between the condensed version of the dictionary column and e identifiers in the dictionary table.

In Example 9, the subject matter of Examples 1-8 includes, wherein the database command involves extraction of a string from each row of the column.

In Example 10, the subject matter of Examples 1-9 includes, wherein the database command involves a join operation performed on the column.

In Example 11, the subject matter of Examples 1-10 includes, wherein the database command involves a filter operation performed on the column.

Example 12 is a method comprising: receiving a database command to be performed on each row of a column of a table in a database; accessing a dictionary table corresponding to the column, the dictionary table including a mapping between identifiers and unique values contained in the column of the table in the database; generating a dictionary column by applying the database command to each unique value contained in the dictionary table; storing the dictionary column; and accessing results of the database command by accessing the dictionary column.

In Example 13, the subject matter of Example 12 includes, wherein each row in the column of the table contains one of the identifiers in the mapping in the dictionary table, indicating that the corresponding unique value in the mapping corresponds to a value for the corresponding row.

In Example 14, the subject matter of Example 13 includes, wherein the accessing results includes using the dictionary column along with the dictionary table to identify values in the dictionary column that correspond to each row of the column of the table in the database.

In Example 15, the subject matter of Example 14 includes, wherein the dictionary column is organized so that each row of the dictionary column lined up with a corresponding row of the dictionary table so that each row of the dictionary column contains a result of applying the database command to a unique value in the corresponding row in the dictionary table.

In Example 16, the subject matter of Examples 14-15 includes, determining whether a ratio of cardinality of the column to number of rows in the column is less than a threshold; and wherein the receiving, accessing, generating, and storing are performed in response to a determination that the ratio of cardinality of the column to number of rows in the column is less than the threshold ratio.

In Example 17, the subject matter of Example 16 includes, wherein the threshold ratio is determined by a machine learning model trained to output an optimal threshold ratio for a particular scenario in which the database command is being executed.

Example 18 is a non-transitory machine-readable medium storing instructions which, when executed by one or more processors, cause the one or more processors to perform operations comprising: receiving a database command to be performed on each row of a column of a table in a database; accessing a dictionary table corresponding to the column, the dictionary table including a mapping between identifiers and unique values contained in the column of the table in the database; generating a dictionary column by applying the database command to each unique value contained in the dictionary table; storing the dictionary column; and accessing results of the database command by accessing the dictionary column.

In Example 19, the subject matter of Example 18 includes, wherein each row in the column of the table contains one of the identifiers in the mapping in the dictionary table, indicating that the corresponding unique value in the mapping corresponds to a value for the corresponding row.

In Example 20, the subject matter of Example 19 includes, wherein the accessing results includes using the dictionary column along with the dictionary table to identify values in the dictionary column that correspond to each row of the column of the table in the database.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

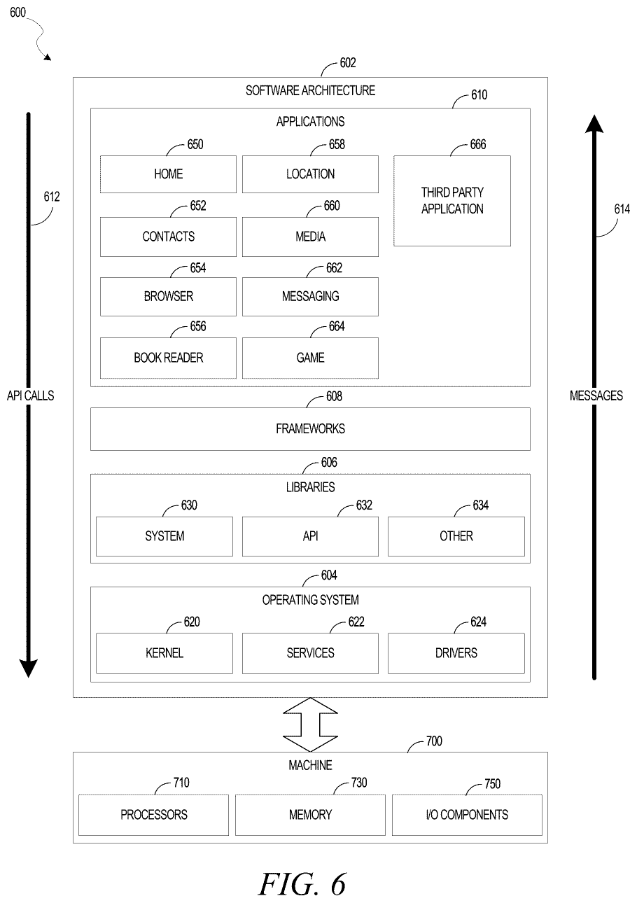

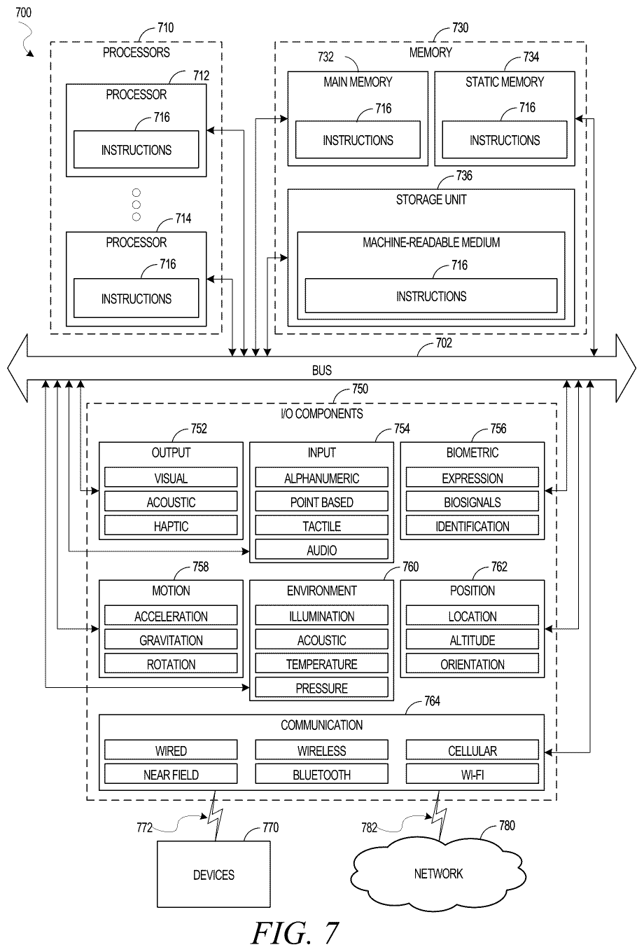

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input/output (I/O) components 750. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware. For instance, the drivers 624 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (PEG or JPG), or Portable Network Graphics (PNG), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610. For example, the frameworks 608 provide various graphical user interface functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. The applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit [SDK] by an entity other than the vendor of the particular platform) may be mobile software running on a mobile operating system such as IOS™, ANDROID™ WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine 700 to perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute the method of FIG. 5. Additionally, or alternatively, the instructions 716 may implement FIGS. 1-5 and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer [or distributed] network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device [e.g., a smart watch], a smart home device [e.g., a smart appliance], other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor D(SP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions 716 contemporaneously. Although FIG. 7 shows multiple processors 710, the machine 700 may include a single processor 712 with a single core, a single processor 712 with multiple cores (e.g., a multi-core processor 712), multiple processors 712, 714 with a single core, multiple processors 712, 714 with multiple cores, or any combination thereof.

The memory 730 may include a main memory 732, a static memory 734, and a storage unit 736, each accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel [PDP], a light-emitting diode (LED) display, a liquid crystal display (LCD), a projector, or a cathode ray tube (CRT), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., coupled via a USB).

Moreover, the communication components 764 may detect identifiers or include components operable to detect identifiers. For example, the communication components 764 may include radio-frequency identification (RFID) tag reader components, NFC smart tag detection components, optical reader components (e.g., an optical sensor to detect one-dimensional bar codes such as Universal Product Code [UPC] bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

The various memories (i.e., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 780 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., Hypertext Transfer Protocol [HTTP]). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

1. A system comprising:
at least one hardware processor; and
a computer-readable medium storing instructions that, when executed by the at least one hardware processor, cause the at least one hardware processor to perform operations comprising:
receiving a database command to be performed on each row of a column of a table in a database, the column having low cardinality;
accessing a dictionary table, stored in the database, corresponding to the column, the dictionary table including a mapping between identifiers and unique values contained in the column of the table in the database;
generating a dictionary column by applying the database command to each unique value contained in the dictionary table, such that values in the dictionary column are generated from the unique values contained in each dictionary table and at least some of the values in the dictionary column are different than the unique values contained in each dictionary table;
storing the dictionary column in the database; and
accessing results of the database command by accessing the dictionary column.

2. The system of claim 1, wherein each row in the column of the table contains one of the identifiers in the mapping in the dictionary table, indicating that the corresponding unique value in the mapping corresponds to a value for the corresponding row.

3. The system of claim 2, wherein the accessing results includes using the dictionary column along with the dictionary table to identify values in the dictionary column that correspond to each row of the column of the table in the database.

4. The system of claim 3, wherein the dictionary column is organized so that each row of the dictionary column lined up with a corresponding single row of the dictionary table so that each row of the dictionary column contains a result of applying the database command to a unique value in the corresponding single row in the dictionary table.

5. The system of claim 1, wherein the operations further comprise:
determining whether a ratio of cardinality of the column to number of rows in the column is less than a threshold; and
wherein the receiving, accessing, generating, and storing are performed in response to a determination that the ratio of cardinality of the column to number of rows in the column is less than the threshold ratio.

6. The system of claim 5, wherein the threshold ratio is determined by a machine learning model trained to output an optimal threshold ratio for a particular scenario in which the database command is being executed.

7. The system of claim 1, wherein the operations further comprise:
breaking the dictionary table into multiple dictionary tables; and
generating separate dictionary columns for each of the multiple dictionary tables using parallel computing.

8. The system of claim 1, wherein the operations further comprise:
generating a condensed version of the dictionary column by eliminating duplicate instances of an identical value in rows of the dictionary column and maintaining a mapping between the condensed version of the dictionary column and the identifiers in the dictionary table.

9. The system of claim 1, wherein the database command involves extraction of a string from each row of the column.

10. The system of claim 1, wherein the database command involves a join operation performed on the column.

11. The system of claim 1, wherein the database command involves a filter operation performed on the column.

12. A method comprising:
receiving a database command to be performed on each row of a column of a table in a database, the column having low cardinality;
accessing a dictionary table, stored in the database, corresponding to the column, the dictionary table including a mapping between identifiers and unique values contained in the column of the table in the database;
generating a dictionary column by applying the database command to each unique value contained in the dictionary table, such that values in the dictionary column are generated from the unique values contained in each dictionary table and at least some of the values in the dictionary column are different than the unique values contained in each dictionary table;
storing the dictionary column in the database; and
accessing results of the database command by accessing the dictionary column.

13. The method of claim 12, wherein each row in the column of the table contains one of the identifiers in the mapping in the dictionary table, indicating that the corresponding unique value in the mapping corresponds to a value for the corresponding row.

14. The method of claim 13, wherein the accessing results includes using the dictionary column along with the dictionary table to identify values in the dictionary column that correspond to each row of the column of the table in the database.

15. The method of claim 14, wherein the dictionary column is organized so that each row of the dictionary column lined up with a corresponding single row of the dictionary table so that each row of the dictionary column contains a result of applying the database command to a unique value in the corresponding single row in the dictionary table.

16. The method of claim 14, further comprising:
determining whether a ratio of cardinality of the column to number of rows in the column is less than a threshold; and
wherein the receiving, accessing, generating, and storing are performed in response to a determination that the ratio of cardinality of the column to number of rows in the column is less than the threshold ratio.

17. The method of claim 16, wherein the threshold ratio is determined by a machine learning model trained to output an optimal threshold ratio for a particular scenario in which the database command is being executed.

18. A non-transitory machine-readable medium storing instructions which, when executed by one or more processors, cause the one or more processors to perform operations comprising:
receiving a database command to be performed on each row of a column of a table in a database, the column having low cardinality;
accessing a dictionary table, stored in the database, corresponding to the column, the dictionary table including a mapping between identifiers and unique values contained in the column of the table in the database;
generating a dictionary column by applying the database command to each unique value contained in the dictionary table, such that values in the dictionary column are generated from the unique values contained in each dictionary table and at least some of the values in the dictionary column are different than the unique values contained in each dictionary table;
storing the dictionary column in the database; and
accessing results of the database command by accessing the dictionary column.

19. The non-transitory machine-readable medium of claim 18, wherein each row in the column of the table contains one of the identifiers in the mapping in the dictionary table, indicating that the corresponding unique value in the mapping corresponds to a value for the corresponding row.

20. The non-transitory machine-readable medium of claim 19, wherein the accessing results includes using the dictionary column along with the dictionary table to identify values in the dictionary column that correspond to each row of the column of the table in the database.
